(19) United States
(12) Patent Application Publication
(10) Pub. No.: US 2026/0030039 A1
(43) Pub. Date: Jan. 29, 2026

(54) CAPABILITIES AND SAFE PLUGINS

(71) Applicant: MICROSOFT TECHNOLOGY LICENSING, LLC, Redmond, WA (US)

(72) Inventors: Justin Daniel HARRIS, Scarborough (CA); Adrian Wyatt BONAR, Seattle, WA (US); Mahmoud ADADA, Montreal (CA); Tudor Buzasu KLEIN, Yokohama (JP)

(21) Appl. No.: 18/784,824

(22) Filed: Jul. 25, 2024

(51) Int. Cl. G06F 9/445; G06F 16/903; G06F 21/51

(52) U.S. Cl. CPC G06F 9/44526; G06F 16/90344; G06F 21/51; G06F 2221/034

(57) ABSTRACT

Disclosed are methods for managing execution of plugins of a machine-learning based system. A plugin configuration defines inputs required by the plugin and capabilities provided by the plugin. Capabilities describe the plugin’s functionality, such as how the plugin affects the response, what type of content the plugin generates, etc. In some configurations, when responding to a prompt, a collection of relevant plugins is identified. Configurations of these plugins may be analyzed to optimize execution, including determining optimal execution order or enabling parallel execution. Plugin configurations may also be analyzed to improve security by conditionally preventing one plugin from accessing the output of another. Plugin configurations may also be used to inform a client what plugins will run and what results they may yield. This enables the client to optimize and streamline how the response is displayed.

### BACKGROUND

Artificial Intelligence (AI) systems encompass various technologies with machine learning (ML) models being a core component. These systems can extend their capabilities with plugins. Plugins utilize specialized algorithms, perform specific tasks, or integrate with other technologies. Plugins allow AI systems to tackle more complex problems and operate more efficiently.

A chatbot receives a prompt such as “what time is it?” and replies with a response such as “two PM.” Some chatbots utilize machine learning and can be augmented with plugins. However, complexity arises when multiple plugins are available and interact with one another.

It is with respect to these and other considerations that the disclosure made herein is presented.

### SUMMARY

Disclosed are methods for managing execution of plugins of a machine-learning based system. A plugin configuration defines inputs required by the plugin and capabilities provided by the plugin. Capabilities describe the plugin’s functionality, such as how the plugin affects the response, what type of content the plugin generates, etc. In some configurations, when responding to a prompt, a collection of relevant plugins is identified. Configurations of these plugins may be analyzed to optimize execution, including determining optimal execution order or enabling parallel execution. Plugin configurations may also be analyzed to improve security by conditionally preventing one plugin from accessing the output of another. Plugin configurations may also be used to inform a client what plugins will run and what results they may yield. This enables the client to optimize and streamline how the response is displayed.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a machine-learning based system that is augmented with plugins.

FIG. 2 illustrates a configuration file of a plugin.

FIG. 3 illustrates a dependency graph of chatbot plugins.

FIG. 4 illustrates a timeline of plugin execution.

FIG. 5 is a flow diagram of an example method for capabilities and safe plugins.

FIG. 6 is a flow diagram of an example method for capabilities and safe plugins.

FIG. 7 is a flow diagram of an example method for capabilities and safe plugins.

FIG. 8 is a computer architecture diagram illustrating an illustrative computer hardware and software architecture for a computing system capable of implementing aspects of the techniques and technologies presented herein.

### DETAILED DESCRIPTION

Machine-learning based systems, referred to herein as “systems,” may use plugins to extend their capability. Plugins may be composed to provide the output of one plugin as input to another. This defines a pipeline of plugins that accepts a prompt as input and provides a response as output. Plugins may also access, modify, or generate metadata or other state that is shared across the pipeline. Task status, task priority, and tags are examples of metadata that may be generated by, passed to, and potentially updated by plugins. One example of state that is shared between plugins is an intermediate result of a complex mathematical computation.

In some configurations the system is itself implemented with composable plugins. This enables third-party plugins that are not part of the system to deeply integrate without having to write custom integration code. For example, the system may expose an integration point that invokes a third-party plugin as a fallback when the system does not know how to respond to a prompt. Third-party plugins may integrate at any point – from when the prompt first arrives until the response is provided, or any point along the way. Examples of built-in plugins include a natural language understanding (NLU) plugin, a plugin that interfaces with a traditional search engine, a plugin that obtains a response from a generative language model, a plugin that applies rules, or the like.

One type of machine-learning based system that utilizes plugins is a chatbot. Many of the examples in this document refer to chatbots, but any kind of machine-learning based system is similarly contemplated, such as agents or personal assistants.

In the context of a chatbot, plugins may add a new message to the conversation, modify or augment messages created by another plugin but not yet returned to the client, modify a final response, return content to the client, modify metadata, or the like. For example, a plugin that helps a user to order pizza may add a new message to the conversation asking the user’s favorite toppings. A plugin that filters out offensive content may modify an existing message in the conversation to remove an offensive term. A plugin that analyzes a response for accuracy may add metadata indicating that a claim made by a previous plugin has been verified by an external source. In an example, a client refers to software that submits prompts to and receives responses from a machine-learning based system. Clients often display responses returned from machine-learning based systems, such as a chatbot client that displays a history of chat messages.

In some configurations, plugins perform these operations according to a standard defined by the chatbot. Standardization enables plugins from different parties to interoperate with one another. For example, a plugin may use standardized key names when inserting key-value pairs in a JavaScript Object Notation (JSON) file that comprises a response. Subsequent plugins in a pipeline of plugins may then reliably retrieve data stored in the standardized way. Standardization allows plugins to communicate, but they also allow dependencies to exist between plugins.

A plugin configuration may declare how a plugin receives a response generated by a previous plugin. The plugin may wait for the previous plugin in the pipeline to create a complete response before beginning. Alternatively, the plugin may elect to receive portions of the response as they are generated, such as paragraphs, sentences, or tokens. Processing a response as a stream of response portions enables the plugin to begin processing significantly sooner than waiting for a complete response. This is particularly useful when the response is produced by a generative language model which may take seconds or even minutes to respond to a single prompt. For example, a speech processing plugin that verbalizes a response may elect to receive the output of the previous plugin as a stream of sentences or words, enabling the response to be spoken as it is generated.

Each plugin is associated with a configuration that declares capabilities it provides, the inputs it requires, and/or any modifications it makes to data being passed through the pipeline. In some configurations, the system enforces a requirement that plugins provide configurations, preventing plugins without configurations from running. When a pipeline contains more than one plugin, the chatbot may analyze the required inputs, the capabilities, and/or data modifications of each plugin to create a dependency graph. Plugins are then executed in order according to the dependency graph.

For example, a social media integration plugin that posts chatbot responses to a social media account may require input that has been deemed inoffensive. An offensiveness detection plugin may have the capability to determine that content is inoffensive. The chatbot identifies that the input requirements of the social media plugin are satisfied by the offensiveness detection capability of the offensiveness detection plugin. Accordingly, the chatbot will construct a dependency graph in which the social media plugin depends on the offensiveness detection plugin. Accordingly, while responding to a prompt, the chatbot will invoke the offensiveness detection plugin first.

Allowing plugins to execute without regard to capabilities has some benefits, such as frictionless development and deployment. However, there are significant downsides, such as allowing sensitive data acquired by one plugin to be unexpectedly exposed to others. Another downside is that without a forward declaration of capabilities, clients that display the chatbot response do not know which plugins return content, and of those that do, what type of content they generate. Not knowing which clients return content may result in the client waiting unnecessarily for a plugin to finish executing, increasing response times. Not knowing what type of content a plugin generates may result in frequently and inelegantly updating the user interface as additional types of content are received.

For example, an image is often added to a response after a text portion of the response has been generated and sent to the client. Some clients may eagerly display the text portion of the response and re-render the response when the image arrives. In an example, eagerly displaying the text portion refers to displaying the text portion after the text portion is received by the client without waiting for other portions of the response to be received. Other clients may wait for the image before rendering any portion of the response. Other clients may anticipate the image as they eagerly render the text portion of the response.

For instance, the client, alone or at the behest of the chatbot, may hold off on certain types of transformations or renderings when an image is expected. For example, the client may wait for all types of content relevant to a portion of the response to be received before rendering that portion of the response. This prevents scenarios in which a user is hovering over text that is not associated with a link, only for the text to unexpectedly turn into a link when the image is received. Additionally, or alternatively, clients that create links to the image may display the text portion of the response but wait for the image to become available before constructing links. This prevents the user interface from refreshing too often. It also prevents scenarios in which a link is displayed before the targeted content is available.

However, clients are unable to perform these actions without knowing which plugins provide images. To address this issue, the chatbot may eagerly inform the client which plugins return which types of content based on capabilities listed in plugin configurations. In one example, eagerly informing the client which plugins are active and the types of content they may return refers to providing this information before or with a first portion of a response. In some configurations, the chatbot may inform the client when all types of content of a portion of the response have been received, allowing the client to update the display.

Adding an image to the response is one example of a capability of a plugin. Other capabilities include adding video or other media content, modifying the text of a response, appending to a response, changing the final response, etc. Capabilities may also indicate which metadata or other shared state is modified by a plugin.

In some configurations, when a number of plugins operate independently, the system may run them in parallel, improving response time. Plugins may be determined to operate independently when they do not modify the same shared state. For example, two plugins that do not modify the pending response may be safely executed in parallel. Plugins that do modify the same shared state are serialized in order to avoid race conditions or other corruption of the shared state.

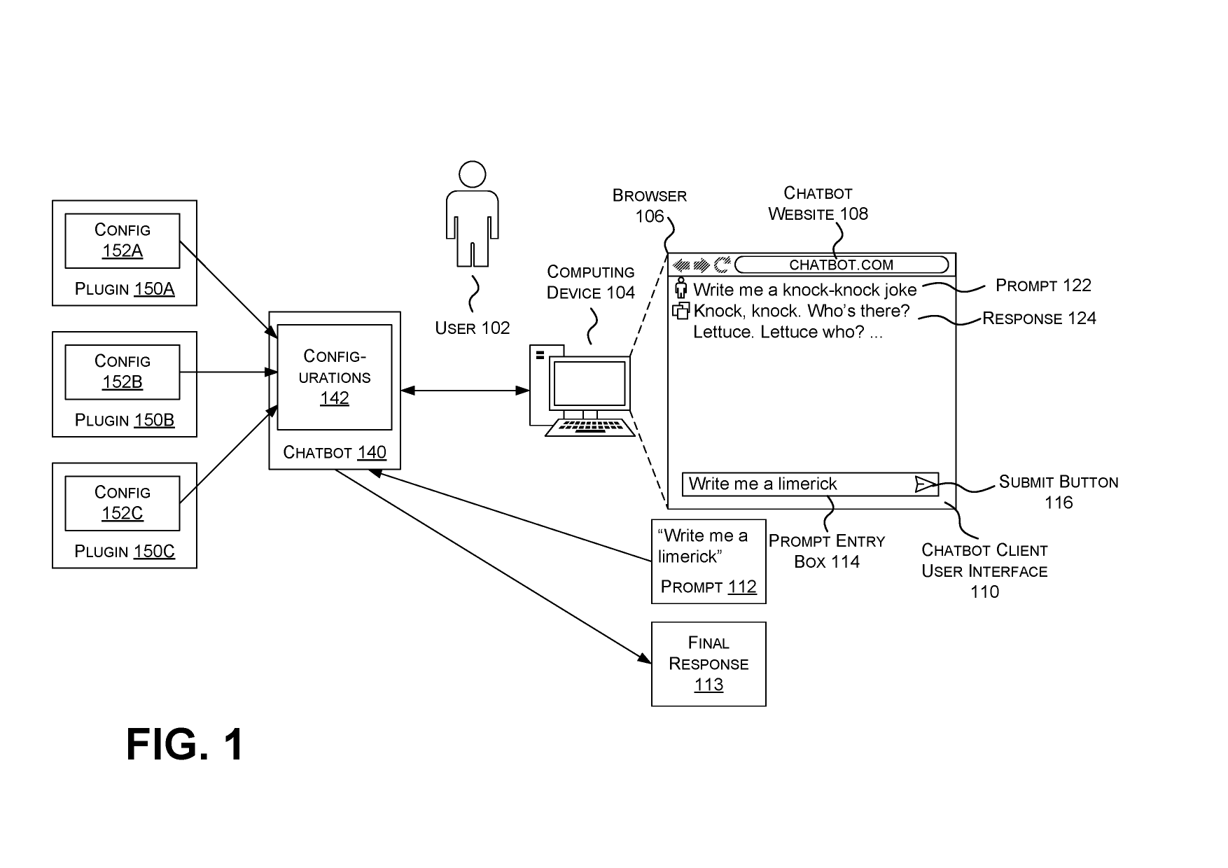

FIG. 1 illustrates a machine-learning based system that is augmented with plugins. User 102 operating computing device 104 may navigate browser 106 to chatbot website 108. Alternatively, chatbot 140 may be exposed to user 102 via an app, or as part of an existing piece of software. A chatbot is one example of a machine-learning based chatbot, which is one example of a machine-learning based system. Chatbot website 108 utilizes a generative language machine learning model to interact with users in a human-like way. Typically, chatbot 140 is hosted by a remote server computing device, although it may also be implemented by computing device 104.

Chatbot client user interface 110 – also referred to as ‘chatbot client user interface 110’ or ‘client 110’ - includes prompt 112 entered into prompt entry box 114. Clicking or otherwise initiating a trigger associated with submit button 116 causes prompt 112 to be submitted to chatbot 140. Chatbot client user interface 110 shows a history of messages between user 102 and chatbot 140, such as prompt 122 and text response 124.

Chatbot 140 contains configurations 142 - one or more configurations 152 that have been registered by or otherwise associated with plugins 150. Plugins 150 extend the capabilities of chatbot 140. Registering a plugin with chatbot 140 makes chatbot 140 aware of the capabilities of that plugin. This enables chatbot 140 to invoke the plugin to leverage the registered capability while responding to prompt 112.

As discussed below in more detail, plugins 150 are composable in that the output of one plugin may be used as input to another plugin. Chatbot plugins are also composable in that they read and write metadata as a request is passed through a pipeline of plugins.

Registered plugins may be invoked by chatbot 140. For example, chatbot 140 may invoke a registered chatbot plugin to browse the internet. Additionally, or alternatively, one or more of chatbot plugins 150 interact with chatbot 140 by providing prompts to chatbot 140, similar to how a user would provide chatbot 140 with prompts. Chatbot plugins may invoke one another and/or chatbot 140.

In some configurations, prompt 112 is responded to over time with multiple responses. Responses may originate from chatbot 140 or one or more plugins 150. Eager response 111 is one example of a first response to prompt 112. Eager response 111 includes text 124 – a first text portion of the response to prompt 112. Eager response 111 may also include an indication of plugins 150 that may run while responding to prompt 112 and/or an indication of content types 117 that may be generated while responding to prompt 112. For example, content type 117 may indicate that a picture-generating plugin is scheduled to run while responding to prompt 112.

Final response 113 is an example of another portion of a response to prompt 112. As illustrated, final response 113 includes content 115. Content 115 may be content that is generated by one of plugins 150. Content 115 may be of content type 117.

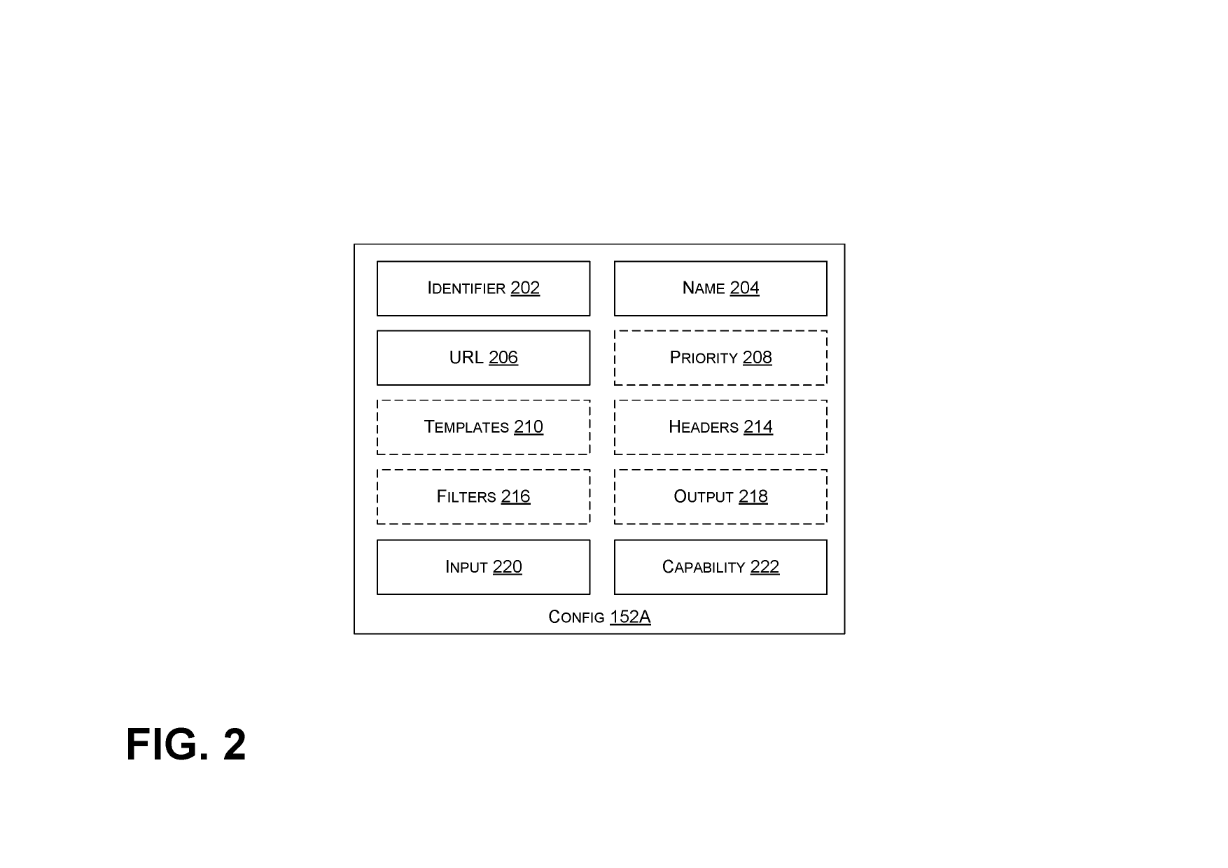

FIG. 2 illustrates a configuration file of a chatbot plugin. Configuration file 152A may include one or more of identifier 202, name 204, Uniform Resource Locator (URL) 206, priority ranking 208, templates 210, headers 214, filters 216, output 218, input 220, and/or capability 222. Configuration file 152 may be a JSON file, XML file or any other human readable markup file. Configuration file 152 may also be computer-readable.

Identifier 202 may be any unique sequence of numbers or letters usable to refer to a particular chatbot plugin. Name 204 refers to a descriptive name of the chatbot plugin 150A associated with configuration 152.

URL 206 is an HTTP endpoint usable by chatbot 140 to invoke chatbot plugin 150A. While web-based chatbot plugins are referred to throughout this document, this is just one example of a technique for referencing a chat bot plugin. Other techniques such as referring to a local executable file are similarly contemplated. When chatbot 140 has determined to invoke a particular chat bot plugin 150, it may do so by submitting an HTTP request to URL 206. in some configurations, URL 206 also describes an HTTP verb or other connection parameter usable to invoke the target chatbot plugin.

Optional priority 208 is an expression of a desired place in a plugin execution pipeline. Execution order is determined dynamically in the context of a particular prompt 112 based on an analysis of inputs 220, outputs 218, and/or capabilities 222 of the relevant plugins. Execution order may also consider priority 208, e.g., as a tie-breaker. Priority 208 may be a rank. In some configurations, a plugin associated with a lower ranking number is executed first, e.g., a plugin with rank 1 is executed before a plugin with rank 2.

Templates 210 are optional strings of text that include references to data contained in a request. Templates 210 allow responses to be dynamically generated based on the structured data obtained from the context user 102 is operating in and from data generated by previous plugins. Templates 210 are used to implement “low-code” plugins – plugins that do not invoke an HTTP based service, but which compute a response based on the request received and based on templates contained in configuration 152A itself. For example, if plugin 152A is provided with a conversation of messages that have already been exchanged between user 102 and chatbot 140, then a template 210 may generate an output based on the text of one or more of the messages in the conversation.

Optional headers 214 include string key-value pairs that may be referenced by a filter 216, a template 210, or other dynamic aspects of a plugin.

Optional filters 216 are conditions that determine whether the corresponding chatbot plugin 150 will process a particular request. If no filter 216 is listed, then the corresponding plugin 150 will be invoked. Similar to templates, which generate an output in response to a request, filters may refer to data included in the request. For example, a filter may return ‘true’ if any of the messages in the conversation include the text ‘order pizza’. If there are multiple filters 216, filters 216 may be considered satisfied if all of filters 216 evaluate to true, or, in some configurations, if at least one of filters 216 evaluates to true. In some configurations, filters 216 use a JSON path to reference data in request 112.

Filters may be based on the text contained in one or more previous messages of the conversation, the number of previous messages, the content of particular messages (such as the first or last message in a conversation). Filters may also refer to a content origin property. For example, a plugin may selectively be run when a content origin of a message in the conversation is a particular search engine. Filters may also be based on metadata generated by previous plugins, such as NLU classifications, whether or not a prompt or previous response was offensive, or the like.

Optional output 218 indicates the outputs of plugin 150A. Output 218 may indicate that plugin 150A generates a text response. Output 218 may also indicate when plugin 150A generates other types of content, such as images, voice, or video. Output 218 may also indicate when plugin 150A emits or modifies metadata that chatbot 140 passes to subsequent plugins of the execution pipeline. For example, output 218 of an NLU classification plugin may declare that it generates a list of named entities.

Output 218 may also describe content generated by no-code plugins. As referred to above, a no-code plugin returns a hard-coded value, such as a string literal. A low-code plugin uses a template to dynamically generate a response based on string literals in the template, template operators such as string concatenation, and reference to data submitted in the request being processed.

Input 220 indicates an optional input or a required input of plugin 150A. Input 220 may define a data type of an input, such as whether the input is text, a number, or an image. Chatbot 140 provides plugin 150A with the listed inputs when plugin 150A is executed. Example inputs include a previously generated prompt 122 received from user 102 or a previously generated response 124 that was returned to user 102. Similarly, input 220 may include a defined number of previous prompts 122 and/or previous responses 124, or an entire conversation history. Input 220 may also specify plugin-generated metadata, or other outputs generated by other plugins.

Capability 222 indicates functionality that plugin 150A provides. Capabilities may clarify what a plugin does when a human reads configuration 152A. Capabilities may also be analyzed by chatbot 140 to optimize execution, such as by efficiently ordering plugin execution. Some examples of plugin capabilities include: add grounding data for an LLM's response, add a response for the user to see directly, add images to a response, modify the text in a response, modify specific metadata of a response, append to a response, add suggested user messages for replies to a response, read user’s documents, e.g., documents on their device or documents in the cloud such as SharePoint or OneDrive.

In some configurations, chatbot 140 enforces capability 222. Without enforcing capabilities 222, plugins 150 may make unpredictable changes or generate unpredictable outputs that must be validated at runtime. This increases how long it takes to respond to prompt 112 and increases the likelihood that an undesirable response is generated.

Plugin capabilities 222 may be analyzed by chatbot 140 to determine when plugins may be safely and correctly run in parallel. For example, if the next three consecutive plugins that will run do not modify the same metadata or only have side-effects that do not conflict, then they can run in parallel and reduce the time that user 102 waits to see the final generated response.

Plugin capabilities 222 may also be used to determine whether to wait for a plugin to respond before sending user 102 the final generated response 113. Without a declaration of what function a plugin performs, chatbot 140 may wait for the plugin to finish before generating final response 113, even if the plugin does not affect the final response.

For example, some plugins may declare that they modify a response. As such, chatbot 140 will wait for these plugins to complete execution, allowing the changes they make to be incorporated in the final response. However, if a plugin declares that it causes a side-effect – a change that is not observable by user 102, such as saving a value to a cache – then chatbot 140 may return final response 113 before the plugin completes execution. This improves the response time of chatbot 140.

Capabilities 222 may also be used to optimize user interface rendering of chatbot client user interface 110. Without knowledge of capabilities 222, it is unknown until a plugin completes execution what output the plugin generates, what metadata the plugin modifies, or whether the plugin affects the final response. As such, chatbot client user interface 110 does not know what types of media to expect to display.

In some configurations, the response to prompt 112 is incremental. Chatbot 140 may include text in a first portion of the response, only to later incorporate an image generated by plugin 150A. Without capability 222 declaring that plugin 150A will generate an image, chatbot client user interface 110 may render the text as if no image is coming, and then suddenly update the user interface to accommodate the image. This provides a poor user interface experience. When capability 222 indicates that plugin 150A will generate an image, chatbot client user interface 110 may render the first portion of the response in anticipation, such as delaying rendering of a link that displays the image.

In some configurations, capability 222 indicates how plugin 150A will modify or build upon other plugins in the pipeline. For example, capability 222 may indicate that it modifies a response generated by a previous plugin, or that it labels a previously generated plugin response. Capabilities 222 may also be used to restrict, limit, or prevent execution of plugin 150A. To this end, capabilities 222 may be compared with a security policy 230 to determine what aspects of a plugin are allowed. For example, security policy 230 might prohibit plugins that can access their location, a document, contacts, media such as photos and videos, and other private information. Chatbot 140 may prohibit or otherwise limit execution of a plugin that declares a capability to access the private information protected by security policy 230. Similarly, an organization’s security policy 230 might forbid their employees from using plugins that can see more than a defined number of previous messages because there could be confidential content in those messages. Similarly, an organization’s security policy 230 might ban plugins that can modify any part of a generated response because those plugins might inject false content or malicious links.

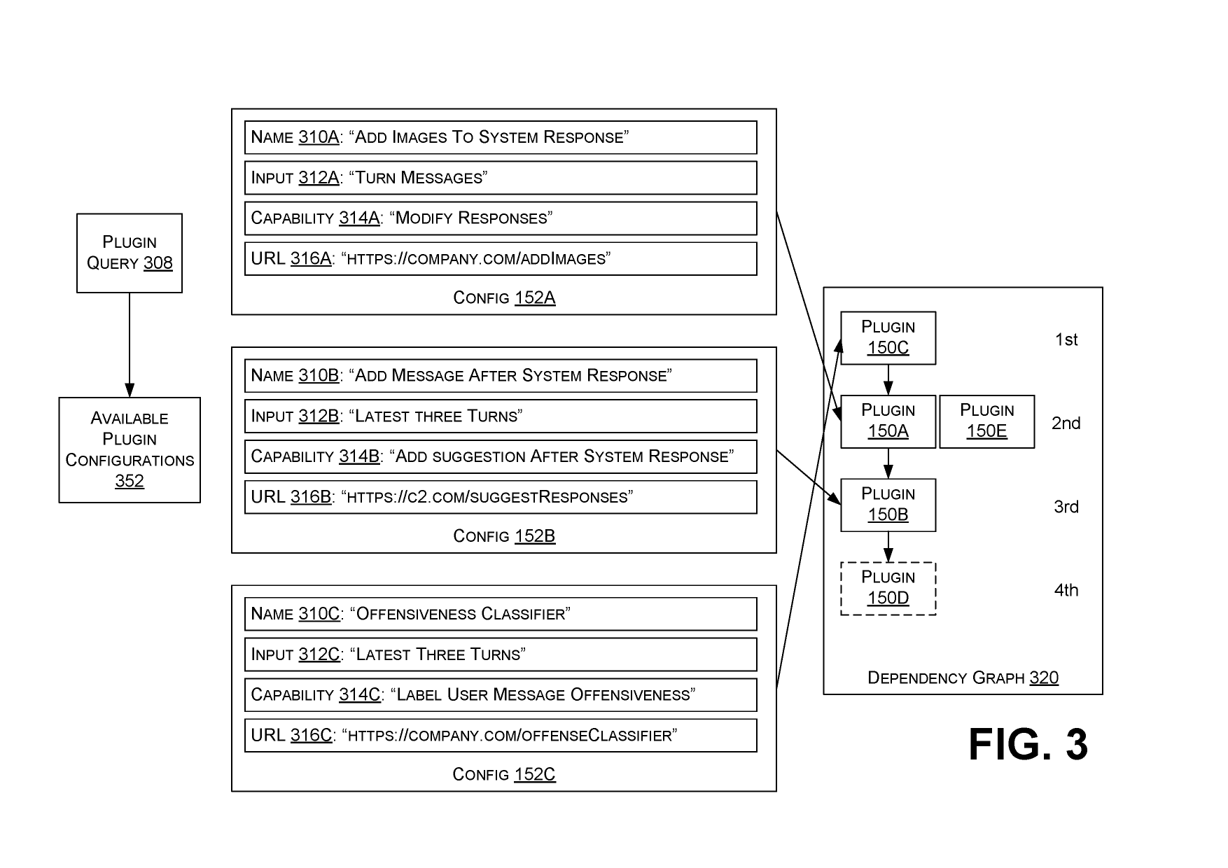

FIG. 3 illustrates a dependency graph 320 of chatbot plugins 150. As illustrated, dependency graph 320 includes plugins 150A-150E. Chatbot 140 may have selected these plugins based on a plugin query 308 of available plugin configurations 352. For example, chatbot 140 may identify key terms from prompt 112 and use these terms in plugin query 308 to search available plugin configurations 352 for relevant plugins. For example, available plugin configurations 352 may be searched for key terms extracted from prompt 112 using string matching, string distance, semantic search, or other string comparison techniques.

Config 152 includes name 310, input 312, capability 314, and URL 316. Name 310A, “add images to system response”, may be descriptive, for use by a system administrator, developer, or a machine learning model that understands unstructured text. Names 310B and 310C similarly describe their respective plugins. URL 316 illustrates one technique for identifying and/or invoking a plugin.

Input 312 refers to the input that plugin 150 accepts. Input 312A, “Turn Messages”, refers to one or more individual messages sent or received during a conversation with chatbot 140. Input 312B and 312C, “latest three turns”, allows plugins 150B and 150C access to the last three messages exchanged between user 102 and chatbot 140. However, these are just some examples of input provided to a chatbot plugin. Other types of machine-learning based systems may refer to still other types of input to a plugin.

Capabilities 314 indicate what a plugin does. Capabilities may be analyzed to order plugins 150 in an efficient manner, enable parallel execution, and apply security restrictions. For example, if one plugin has the capability to return authoritative information, a security policy may prevent subsequent plugins from modifying its response. Capabilities 314 may be selected from a predefined list or dynamically interpreted by a machine learning model.

Capability 314A, “Modify Responses”, indicates that plugin 150A will modify a response generated by a previous plugin. Accordingly, chatbot 140 may place plugin 150A after at least one other plugin, ensuing that there is a plugin-generated response to modify. Capability 314A may also be used in some circumstances to restrict execution of a plugin based on a security policy, as discussed above.

Capability 314B, “add suggestion after system response”, operates on the response that is about to become final response 113. Accordingly, chatbot 140 places plugin 150B after plugins 150C and 150A, ensuring that plugin 150B has the opportunity to operate on final response 113.

Capability 314C, “label user message offensiveness” also processes the latest three turns. Capability 314C indicates that plugin 150C operates on “user messages”, not plugin generated responses. Accordingly, plugin 150C may be placed towards the beginning of dependency graph 320, before other plugins are executed.

Plugin 150D, while not illustrated in detail, depicts a plugin that runs after plugin 150B, but which does not add to or modify final response 113. For example, plugin 150D may cache recently used data or perform a telemetry operation.

Plugin 150E, while also not illustrated in detail, depicts a plugin that does not conflict with plugin 150A. For example, plugins 150A and 150E do not modify the same metadata or other shared state. This allows plugins 150E and 150A to appear in parallel in dependency graph 320. Dependency graph 320 illustrates the final execution order of plugins selected from available plugin configurations 352.

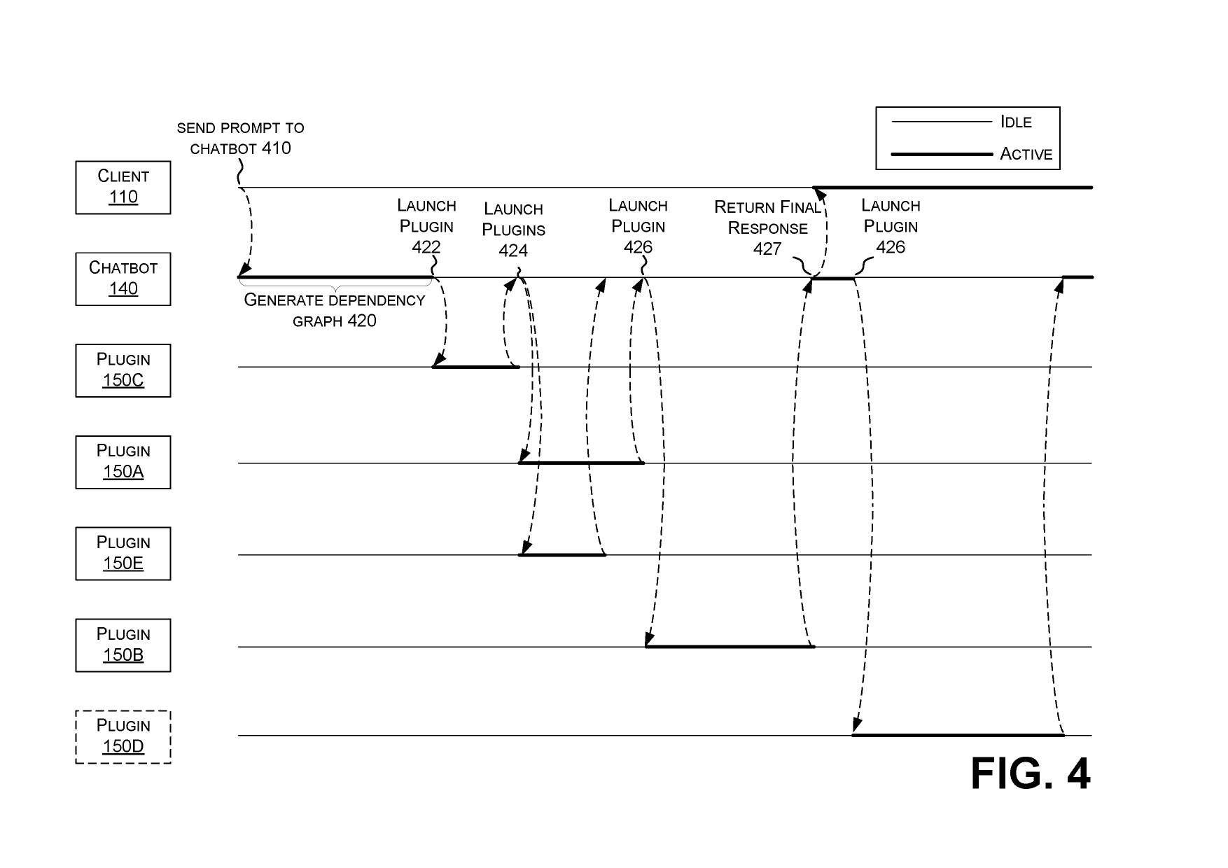

FIG. 4 illustrates a timeline of plugin execution. A thin line indicates that the client/chatbot/plugin is idle, at least with respect to this execution flow. A thick line indicates active use. Dotted lines indicate how execution flows to and from plugins 150, chatbot 140, and chatbot client user interface 110. Chatbot 140 executes plugins 150 according to dependency graph 320. Plugin execution is optimized by parallelizing plugins 150A and 150E and returning final response 113 to chatbot client user interface 110 before plugin 150D completes.

Send prompt to chatbot 410 illustrates chatbot client user interface 110 sending prompt 112 to chatbot 140. Generate dependency graph 420 illustrates chatbot 140, or an orchestration component thereof, obtaining a list of selected plugins from the list of available plugins 352 and analyzing their configurations to obtain dependency graph 320.

Launch plugin 422 illustrates chatbot 140 executing the first plugin of dependency graph 320 – plugin 150C. Chatbot 140 may sit idle waiting for plugin 150C to return, or chatbot 140 may attend to other tasks. Plugin 150C is executed first, before subsequent plugins of dependency graph 320, because at least one dependency exists between plugin 150C and the subsequent plugins. For example, plugin 150C may generate a response that subsequent plugins process with one of their capabilities.

When plugin 150C completes, execution returns to chatbot 140. Launch plugins 424 then launches plugins 150A and 150E in parallel, according to dependency graph 320. Plugins 150A and 150E may run concurrently, reducing the total time it takes to respond to prompt 112.

Once both plugins 150A and 150E complete, chatbot 140 continues execution with launch plugin 426, which launches plugin 150B. When plugin 150B completes, execution returns to chatbot 140, where it is determined that plugin 150B is the last plugin that affects final response 113. As such, return final response 427 returns final response 113 to chatbot client user interface 110.

Before, during, or after returning final response 113 to chatbot client user interface 110, chatbot 140 performs launch plugin 426, which launches plugin 150D. Dependency graph 320 indicates that plugin 150D does not affect final response 113. For example, plugin 150 D may cache a value computed by one of the other plugins.

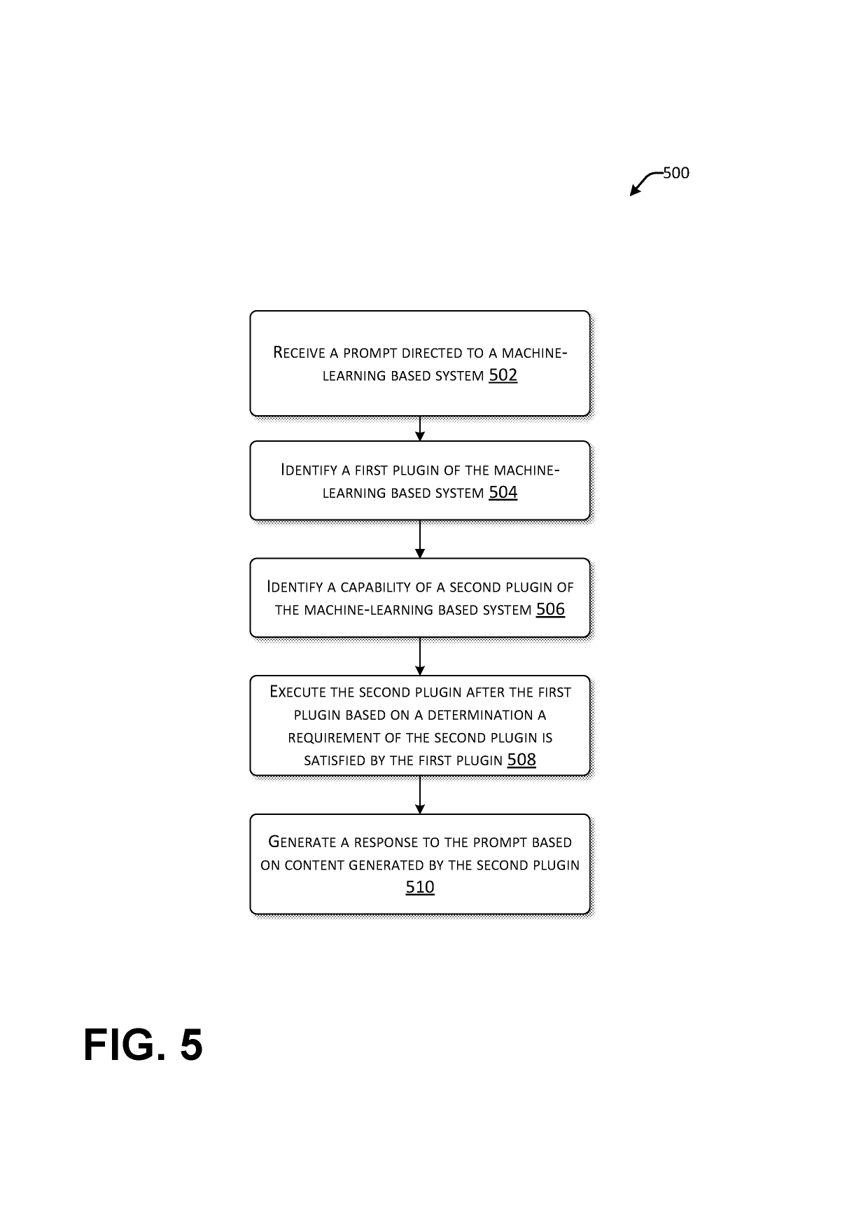

With reference to FIG. 5, routine 500 begins at operation 502, where prompt 112 directed to a machine-learning based system such as chatbot 140.

At operation 504, a first plugin 150C of chatbot 140 is identified. In some configurations, plugin 150C of chatbot 140 is identified as a first plugin of dependency graph 320.

At operation 506, a capability 314A of a second plugin 150A is identified. The capability 314A indicates a dependency on the first plugin 150C. As illustrated, capability 314A analyzes a response generated by a previously executed plugin, and so chatbot 140 places plugin 150A after other plugins in order to increase or maximize how many responses it may analyze. Other capabilities may depend on particular metadata or shared state generated by a plugin, outputs generated by a no-code extension, etc.

At operation 508, the second plugin 150A is executed after the first plugin 150C. In some configurations, this ordering is based on the dependency between plugins 150A and 150C discussed above.

At operation 510, response 113 is generated based in part on a response or other content generated by plugin 150A.

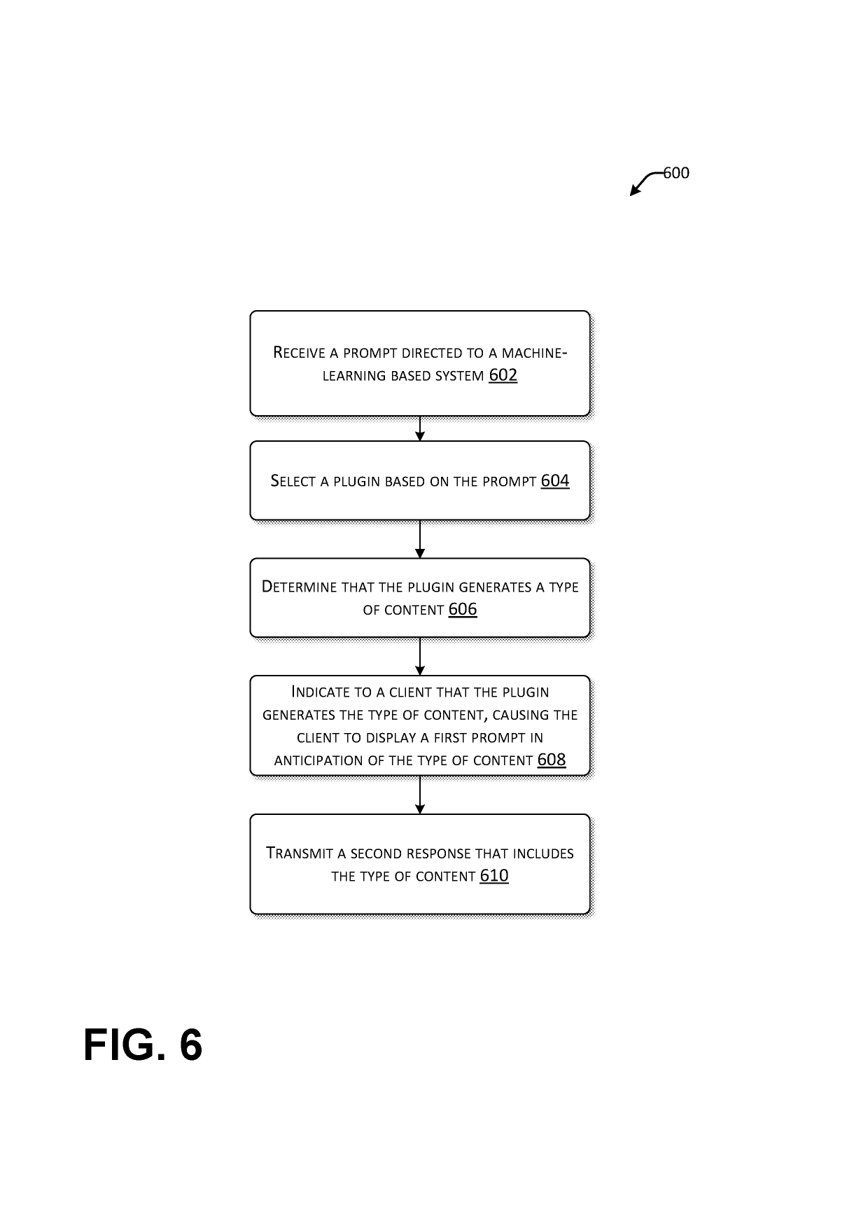

With reference to FIG. 6, routine 600 begins at operation 602, where prompt 112 directed to a machine-learning based system such as chatbot 140.

At operation 604, a plugin 150 of chatbot 140 is identified based on prompt 112. In some configurations, the plugin is identified based on a natural language processing comparison of prompt 112 and the capabilities, names, and/or inputs of available prompts 352. However, direct string comparison, machine learning models, or other techniques for comparison are similarly contemplated.

At operation 606, chatbot 140 determines that the plugin 150 generates a particular type of content 117.

At operation 608, chatbot 140 eagerly informs chatbot client user interface 110 that the plugin generates the type of content 117. In some configurations, chatbot 140 informs chatbot client user interface 110 of any plugins that are included in dependency graph 320, or any plugins included in dependency graph 320 that output content types other than text.

In some configurations, eagerly informing chatbot client user interface 110 that a particular plugin generates a given type of content causes chatbot client user interface 110 to adjust how it outputs a response. In particular, chatbot client user interface 110 may delay rendering a first response portion of a plurality of response portions. In this way, responses are rendered complete with the additional type of content. Additionally, or alternatively, chatbot client user interface 110 may render a first response portion in anticipation of the additional type of content, such as reserving a region of a display for the additional type of content.

Chatbot client user interface 110 may also selectively enable or disable controls that display the additional type of content when it becomes available. For example, client user interface 110 may be locked, such as by disabling a button or otherwise making a button unable to be clicked, until the additional type of content becomes available. Client user interface 110 may make this determination based on an analysis of dependency graph 320, such as based on a determination that at least one plugin that continues to execute will affect the user interface. For instance, a button that submits a subsequent response may be disabled until the final response 113, including any additional content or media, is displayed. Chatbot 140 may instruct client user interface 110 to disable the button explicitly, or client user interface 110 may determine to disable the button based on dependency information received from chatbot 140.

Additionally, or alternatively, client user interface 110 may eagerly enable a portion of client user interface 110 based on an analysis of dependency graph 320. For example, client user interface 110 may eagerly enable a button before the instant request is finished based on a signal from chatbot 140 that plugins 150 that have yet to complete do not affect the user interface.

Next at operation 610, a second response that includes the additional type of content is transmitted to chatbot client user interface 110.

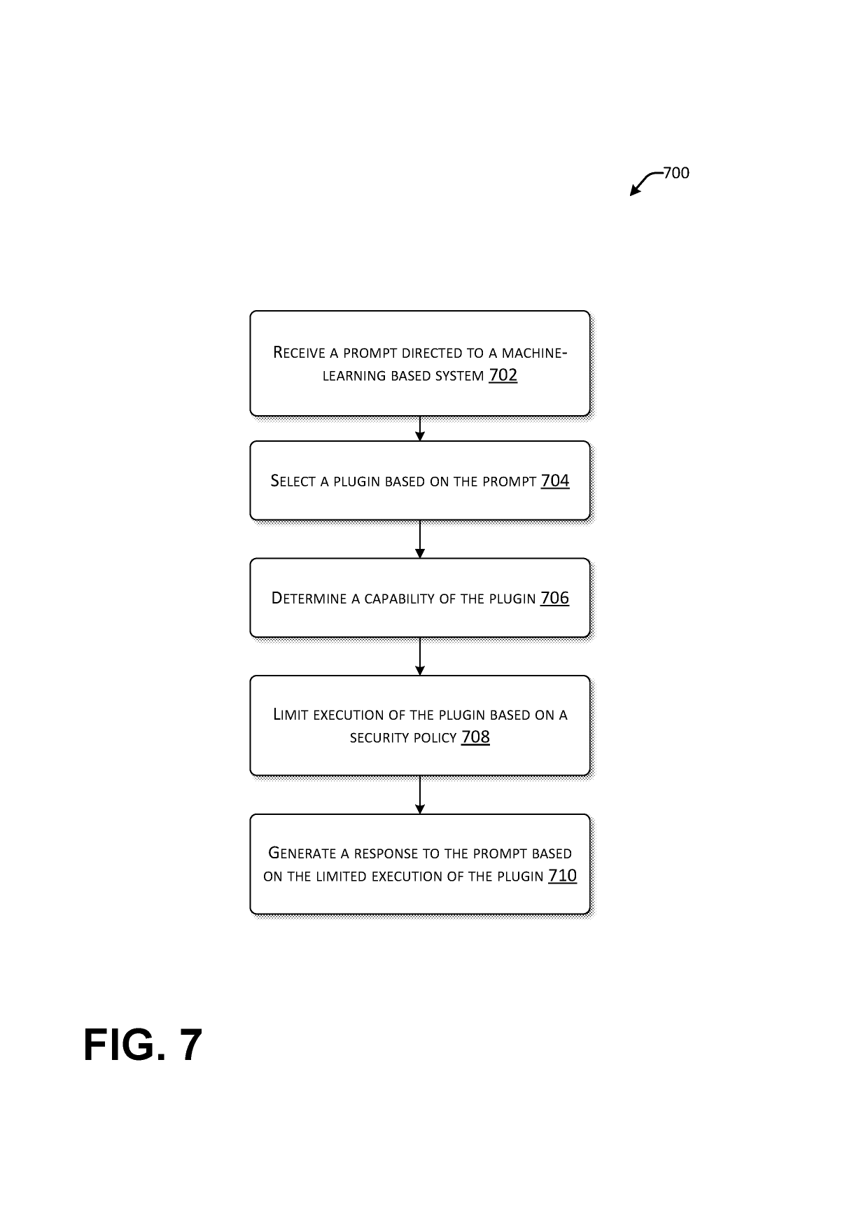

With reference to FIG. 7, routine 700 begins at operation 702, where prompt 112 directed to a machine-learning based system such as chatbot 140.

At operation 704, a plugin 150 of chatbot 140 is identified based on prompt 112, as discussed above in conjunction with operation 604 of FIG. 6.

At operation 706, chatbot 140 determines a capability 314 of the plugin 150.

At operation 708, chatbot 140 limits execution of plugin 150 based on a security policy. The security policy may limit execution of plugin 150 based on a determination that a plugin that appears earlier in dependency graph 320 makes available sensitive information. This prevents the plugin 150 from accessing the sensitive information in accordance with the security policy.

At operation 710, final response 113 is generated based in part on the limited execution of plugin 150.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routines 500, 600, and 700 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routines 500, 600, and 700 may be also implemented in many other ways. For example, the routines 500, 600, and 700 may be implemented, at least in part, by a processor of another remote computer or a local circuit. In addition, one or more of the operations of the routines 500, 600, and 700 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

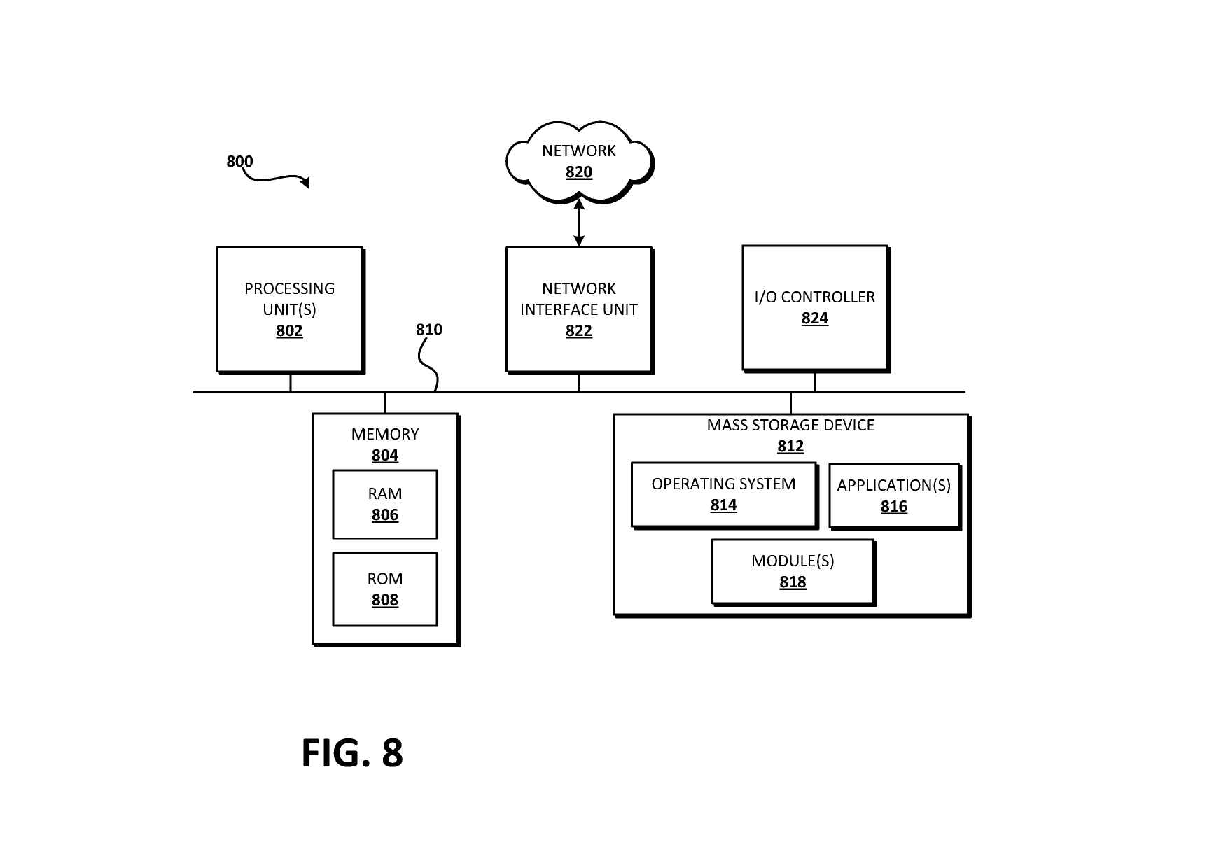

FIG. 8 shows additional details of an example computer architecture 800 for a device, such as a computer or a server configured as part of the systems described herein, capable of executing computer instructions (e.g., a module or a program component described herein). The computer architecture 800 illustrated in FIG. 8 includes processing unit(s) 802, a system memory 804, including a random-access memory 806 (“RAM”) and a read-only memory (“ROM”) 808, and a system bus 810 that couples the memory 804 to the processing unit(s) 802.

Processing unit(s), such as processing unit(s) 802, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), Neural Processing Unites (NPUs) etc.

A basic input/output system containing the basic routines that help to transfer information between elements within the computer architecture 800, such as during startup, is stored in the ROM 808. The computer architecture 800 further includes a mass storage device 812 for storing an operating system 814, application(s) 816, modules 818, and other data described herein.

The mass storage device 812 is connected to processing unit(s) 802 through a mass storage controller connected to the bus 810. The mass storage device 812 and its associated computer-readable media provide non-volatile storage for the computer architecture 800. Although the description of computer-readable media contained herein refers to a mass storage device, it should be appreciated by those skilled in the art that computer-readable media can be any available computer-readable storage media or communication media that can be accessed by the computer architecture 800.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 800 may operate in a networked environment using logical connections to remote computers through the network 820. The computer architecture 800 may connect to the network 820 through a network interface unit 822 connected to the bus 810. The computer architecture 800 also may include an input/output controller 824 for receiving and processing input from a number of other devices, including a keyboard, mouse, touch, or electronic stylus or pen. Similarly, the input/output controller 824 may provide output to a display screen, a printer, or other type of output device.

It should be appreciated that the software components described herein may, when loaded into the processing unit(s) 802 and executed, transform the processing unit(s) 802 and the overall computer architecture 800 from a general-purpose computing system into a special-purpose computing system customized to facilitate the functionality presented herein. The processing unit(s) 802 may be constructed from any number of transistors or other discrete circuit elements, which may individually or collectively assume any number of states. More specifically, the processing unit(s) 802 may operate as a finite-state machine, in response to executable instructions contained within the software modules disclosed herein. These computer-executable instructions may transform the processing unit(s) 802 by specifying how the processing unit(s) 802 transition between states, thereby transforming the transistors or other discrete hardware elements constituting the processing unit(s) 802.

The present disclosure is supplemented by the following example clauses:

Example 1: A method comprising: receiving a prompt directed to a machine-learning based system; constructing a plugin query based on the prompt; querying a plurality of plugin configurations with the plugin query to identify a first plugin of the machine-learning based system; identifying a capability of a second plugin of the machine-learning based system; executing the second plugin after the first plugin based on a determination that a requirement of the capability of the second plugin is satisfied by the first plugin; and generating a response to the prompt based in part on content generated by the second plugin.

Example 2: The method of Example 1, further comprising: querying the plurality of plugin configurations to identify a third plugin associated with the prompt; and executing the second plugin and the third plugin in parallel based on a determination that the second plugin and the third plugin execute independently.

Example 3: The method of Example 2, wherein the second plugin and the third plugin are determined to execute independently based on a determination that the second plugin and the third plugin have non-conflicting side effects.

Example 4: The method of Example 2, wherein the second plugin and the third plugin are arranged in a plugin pipeline that shares state between plugins in the plugin pipeline, and wherein the second plugin and the third plugin are determined to execute independently of each other based on a determination that the second plugin and the third plugin do not modify the shared state of the plugin pipeline.

Example 5: The method of Example 1, wherein the second plugin is executed after any other plugins based on a determination that a capability of the second plugin modifies a final generated response to the prompt.

Example 6: The method of Example 5, wherein the first plugin generates an intermediate response to the request, and wherein the second plugin executes after the first plugin based on a determination that the capability of the second plugin modifies the intermediate response.

Example 7: The method of Example 1, further comprising: extracting a keyword from the prompt, wherein the plugin query searches for the keyword in the plurality of plugin configurations.

Example 8: The method of Example 1, wherein the response comprises a first partial response generated by the first plugin, wherein the first partial response is one of a plurality of partial responses delivered over time to a client that provided the prompt, the method further comprising: indicating to the client that the first plugin will provide a piece of content related to the first partial response in a subsequent one of the plurality of partial responses.

Example 9: A computer-readable storage medium having computer-executable instructions stored thereupon that, when executed by a processing system, cause the processing system to: receive a prompt directed to a machine-learning based system; query a plurality of plugin configurations with a plugin query based on the prompt to select a plugin; determine from a capability of a plugin configuration of the selected plugin that the selected plugin generates a type of content; indicate to a client that generated the prompt that the selected plugin generates the type of content, causing the client to display a first response to the prompt with anticipation of a piece of content of the type of content; transmit a second response to the client that includes the piece of content of the type of content.

Example 10: The computer-readable storage medium of Example 9, wherein the second response causes the client to modify the display of the first response based on the piece of content.

Example 11: The computer-readable storage medium of Example 10, wherein the piece of content comprises an image, wherein the modification to the display of the first response comprises adding a link, and wherein activating the link causes the image to be displayed.

Example 12: The computer-readable storage medium of Example 10, wherein the indication to the client that the selected plugin generates the type of content causes the client to modify when a user interface control is enabled.

Example 13: The computer-readable storage medium of Example 9, wherein the plugin query performs a string comparison of a keyword extracted from the prompt to the plurality of plugin configurations.

Example 14: The computer-readable storage medium of Example 9, wherein the indication to the client is sent eagerly, before the first response is sent to the client.

Example 15: A processing system, comprising: a processor; and a computer-readable storage medium having computer-executable instructions stored thereupon that, when executed by the processor, cause the processing system to: receive a prompt directed to a machine-learning based system; construct a plugin query based on the prompt; query a plurality of plugin configurations with the plugin query to select a plugin; determine a capability of the selected plugin; limit execution of the selected plugin based on a determination that a security policy limits execution of individual plugins with the determined capability; and generate a response to the prompt based on the limited execution of the selected plugin.

Example 16: The processing system of Example 15, wherein the capability of the selected plugin accesses a user location, a document, a contact, or a piece of media, wherein the security policy prohibits plugins that can access the user location, the document, the content, or the piece of media, and wherein execution is limited by preventing execution of the selected plugin.

Example 17: The processing system of Example 15, wherein the capability of the selected plugin accesses more than a defined number of previous chatbot messages, and wherein execution is limited by preventing execution of the selected plugin.

Example 18: The processing system of Example 15, wherein the selected plugin comprises a first plugin, wherein execution of the first plugin is limited based on a determination that a second plugin has a defined capability and the second plugin runs before the first plugin.

Example 19: The processing system of Example 18, wherein the defined capability makes private data available to subsequent plugins.

Example 20: The processing system of Example 18, wherein execution of the first plugin is limited based on a determination that the first plugin has a lower level of trust than the second plugin.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a prompt directed to a machine-learning based system;
constructing a plugin query based on the prompt;
querying a plurality of plugin configurations with the plugin query to identify a first plugin of the machine-learning based system;
identifying a capability of a second plugin of the machine-learning based system;
executing the second plugin after the first plugin based on a determination that a requirement of the capability of the second plugin is satisfied by the first plugin; and
generating a response to the prompt based in part on content generated by the second plugin.

2. The method of claim 1, further comprising:
querying the plurality of plugin configurations to identify a third plugin associated with the prompt; and
executing the second plugin and the third plugin in parallel based on a determination that the second plugin and the third plugin execute independently.

3. The method of claim 2, wherein the second plugin and the third plugin are determined to execute independently based on a determination that the second plugin and the third plugin have non-conflicting side effects.

4. The method of claim 2, wherein the second plugin and the third plugin are arranged in a plugin pipeline that shares state between plugins in the plugin pipeline, and wherein the second plugin and the third plugin are determined to execute independently of each other based on a determination that the second plugin and the third plugin do not modify the shared state of the plugin pipeline.

5. The method of claim 1, wherein the second plugin is executed after any other plugins based on a determination that a capability of the second plugin modifies a final generated response to the prompt.

6. The method of claim 5, wherein the first plugin generates an intermediate response to the request, and wherein the second plugin executes after the first plugin based on a determination that the capability of the second plugin modifies the intermediate response.

7. The method of claim 1, further comprising:
extracting a keyword from the prompt, wherein the plugin query searches for the keyword in the plurality of plugin configurations.

8. The method of claim 1, wherein the response comprises a first partial response generated by the first plugin, wherein the first partial response is one of a plurality of partial responses delivered over time to a client that provided the prompt, the method further comprising:
indicating to the client that the first plugin will provide a piece of content related to the first partial response in a subsequent one of the plurality of partial responses.

9. A computer-readable storage medium having computer-executable instructions stored thereupon that, when executed by a processing system, cause the processing system to:
receive a prompt directed to a machine-learning based system;
query a plurality of plugin configurations with a plugin query based on the prompt to select a plugin;
determine from a capability of a plugin configuration of the selected plugin that the selected plugin generates a type of content;
indicate to a client that generated the prompt that the selected plugin generates the type of content, causing the client to display a first response to the prompt with anticipation of a piece of content of the type of content;
transmit a second response to the client that includes the piece of content of the type of content.

10. The computer-readable storage medium of claim 9, wherein the second response causes the client to modify the display of the first response based on the piece of content.

11. The computer-readable storage medium of claim 10, wherein the piece of content comprises an image, wherein the modification to the display of the first response comprises adding a link, and wherein activating the link causes the image to be displayed.

12. The computer-readable storage medium of claim 10, wherein the indication to the client that the selected plugin generates the type of content causes the client to modify when a user interface control is enabled.

13. The computer-readable storage medium of claim 9, wherein the plugin query performs a string comparison of a keyword extracted from the prompt to the plurality of plugin configurations.

14. The computer-readable storage medium of claim 9, wherein the indication to the client is sent eagerly, before the first response is sent to the client.

15. A processing system, comprising:
a processor; and
a computer-readable storage medium having computer-executable instructions stored thereupon that, when executed by the processor, cause the processing system to:
receive a prompt directed to a machine-learning based system;
construct a plugin query based on the prompt;
query a plurality of plugin configurations with the plugin query to select a plugin;
determine a capability of the selected plugin;
limit execution of the selected plugin based on a determination that a security policy limits execution of individual plugins with the determined capability; and
generate a response to the prompt based on the limited execution of the selected plugin.

16. The processing system of claim 15, wherein the capability of the selected plugin accesses a user location, a document, a contact, or a piece of media, wherein the security policy prohibits plugins that can access the user location, the document, the content, or the piece of media, and wherein execution is limited by preventing execution of the selected plugin.

17. The processing system of claim 15, wherein the capability of the selected plugin accesses more than a defined number of previous chatbot messages, and wherein execution is limited by preventing execution of the selected plugin.

18. The processing system of claim 15, wherein the selected plugin comprises a first plugin, wherein execution of the first plugin is limited based on a determination that a second plugin has a defined capability and the second plugin runs before the first plugin.

19. The processing system of claim 18, wherein the defined capability makes private data available to subsequent plugins.

20. The processing system of claim 18, wherein execution of the first plugin is limited based on a determination that the first plugin has a lower level of trust than the second plugin.
